(19) United States
(12) Patent Application Publication
(10) Pub. No.: US 2013/0132295 A1
(43) Pub. Date: May 23, 2013

(54) MOVING COST ESTIMATION SYSTEM

(71) Applicant: Free Moving Price.Com, Inc., Sunrise, FL (US)

(72) Inventors: Alan Horowitz, Sunrise, FL (US); Mitchell Fields, Needham, MA (US)

(73) Assignee: FREE MOVING PRICE.COM, INC., Sunrise, FL (US)

(21) Appl. No.: 13/740,834

(22) Filed: Jan. 14, 2013

(51) Int. Cl. G06Q 30/02

(52) U.S. Cl. CPC G06Q 30/0284
USPC 705/330

(57) ABSTRACT

A system for estimating costs associated with relocating a plurality of items is provided. The system includes an apparatus. The apparatus includes a receiver that receives user input data associated with relocating a plurality of items. The apparatus includes a processor that provides an interface to at least one device. The interface that receives the user input data associated with relocating a plurality of items. The interface transmits user input data to the apparatus. The interface calculates a plurality of cost estimates that includes a total moving cost. The plurality of cost estimates are based at least in part on cost data and the user input data. At least one of the plurality of cost estimates is dynamically updated after at least a portion of the user input data is transmitted. The processor determines the cost data associated with the received user input data.

### STATEMENT REGARDING FEDERALLY SPONSORED RESEARCH OR DEVELOPMENT

n/a

### FIELD OF THE INVENTION

The present invention relates to a method and system for estimating moving cost.

### BACKGROUND OF THE INVENTION

Moving personal or business property can be a complicated and often time consuming process. The moving process may require several types of services such as packers, haulers and temporary storage services in which each service provider may require prolonged telephone conversations or inspections in order to generate a quote for a specific service. For example, a packing and hauling service provider may have to visit a home or business in order to inspect the items to be moved. Rarely does the on-site inspector generate a quote for these services on the spot such that the consumer will have to wait days to receive the quote.

Moreover, as moving companies typically have limited personnel, a customer may have to make an appointment days, even weeks, in advanced just to get the inspector to visit the property. Also, some companies charge customers an inspection fee just to have an inspector visit the property. In other words, some companies charge a fee just to generate a quote. Some moving service providers have tried to simplify the quote process by prompting the consumer to fill out online questionnaires such that pertinent moving information is received by the provider. However, most of the time, these online questionnaires are simply lead generation forms in which the moving service provider will subsequently contact the customer to set up an inspection. Even if the online questionnaire leads to a quote without having an inspector visit the property, the provided quote is not instant as the consumer is often directed to call a contact number at the end of the questionnaire process in order to get the quote.

Some moving service providers supply an online quote but these moving service providers are typically limited to small “do-it-yourself” moves in which the customer is renting a moving vehicle and buying moving supplies. These moving service providers typically do not provide packing/unpacking services. Further, the online quotes are not customizable in that the user is required to re-enter all his/her information if another quote or modified quote is desired. For example, if the calculated quote is too high, the user will have to re-submit all the related user information in order to acquire another online quote that is hopefully more in-line with the consumer's budget. This process is often frustrating to the consumer and may lead to lower customer conversion, i.e., the customer actually using the moving service provider's services.

Moreover, the provided online quote is only one moving service in a move that will likely required several different moving services. For example, while the customer can get an online quote for renting a moving truck, the same customer has to visit another website to get another price quote for packing/unpacking services. In other words, having to visit multiple websites to get various prices quotes for different moving services may quickly lead to user frustration, thereby further inhibiting customer conversion.

### SUMMARY OF THE INVENTION

The present invention advantageously provides a method and system for estimating moving cost.

In accordance with another aspect of the invention, a system for estimating costs associated with relocating a plurality of items is provided. The system including an apparatus. The apparatus including a receiver arranged to receive user input data associated with relocating a plurality of items. The apparatus further including a processor configured to provide an interface to at least one device. The interface configured to receive the user input data associated with relocating a plurality of items. The interface further configured to transmit user input data to the apparatus. The interface further configured to calculate a plurality of cost estimates that includes a total moving cost. The plurality of cost estimates are based at least in part on cost data and the user input data. At least one of the plurality of cost estimates is dynamically updated after at least a portion of the user input data is transmitted. The interface is further configured to display the calculated plurality of cost estimates. The processor is further configured to determine the cost data associated with the received user input data. The apparatus further includes a transmitter arranged to transmit the cost data.

In accordance with another aspect of the invention, a method for estimating costs associated with relocating a plurality of items is provided. User input data associated with relocating a plurality of items is received. The user input data is transmitted. Cost data is received in response to the transmitted user input data. At least a portion of the cost data is predefined by a moving service provider. A plurality of cost estimates including a total moving cost is calculated. The plurality of cost estimates are based at least in part on cost data and the user input data. At least one of the plurality of cost estimates are dynamically updated after at least a portion of the user input data is transmitted. The calculated plurality of cost estimates are displayed.

In accordance with another aspect of the invention, a method for estimating costs associated with relocating a plurality of items is provided. A website interface is provided to at least one device. User data input from the website interface is received. The user input data is associated with relocating a plurality of items. Cost data associated with the user input data is determined. The determined cost data is transmitted to the website interface for use in calculating a plurality of cost estimates. At least a portion of the cost data is predefined by a moving service provider.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary moving cost estimation system, constructed in accordance with the principles of the present invention;

FIG. 2 is a first page of an exemplary interface, constructed in accordance with the principles of the present invention;

FIG. 3 is a second page of the exemplary interface, constructed in accordance with the principles of the present invention;

FIG. 4 is a third page of the exemplary interface, constructed in accordance with the principles of the present invention;

FIG. 5 is a fourth page of the exemplary interface, constructed in accordance with the principles of the present invention;

FIG. 6 is a fifth page of the exemplary interface, constructed in accordance with the principles of the present invention;

FIG. 7 is a sixth page of the exemplary interface, constructed in accordance with the principles of the present invention;

FIG. 8 is a flow chart of an exemplary cost process in accordance with the principles of the present invention; and

FIG. 9 is a flow chart of an exemplary interface process in accordance with the principles of the present invention.

### DETAILED DESCRIPTION OF THE INVENTION

The present invention advantageously provides an apparatus, system and method for moving cost estimation. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

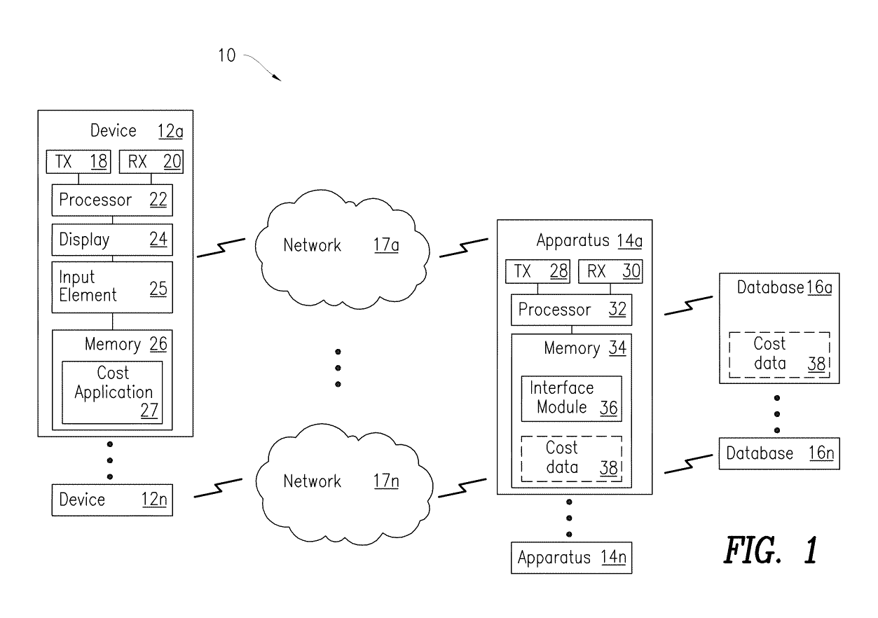

Referring now to drawing figures in which like reference designators refer to like elements there is shown in FIG. 1 an exemplary moving cost estimation system constructed in accordance with the principles of the present invention and designated generally as “10.” System 10 includes one or more devices 12a to 12n (collectively referred to as “device 12”), one or more apparatuses 14a to 14n (collectively referred to as “apparatus 14”), one or more databases 16 (collectively referred to as “database 16”) and one or more communication networks 17a to 17n (collectively referred to as “network 17”).

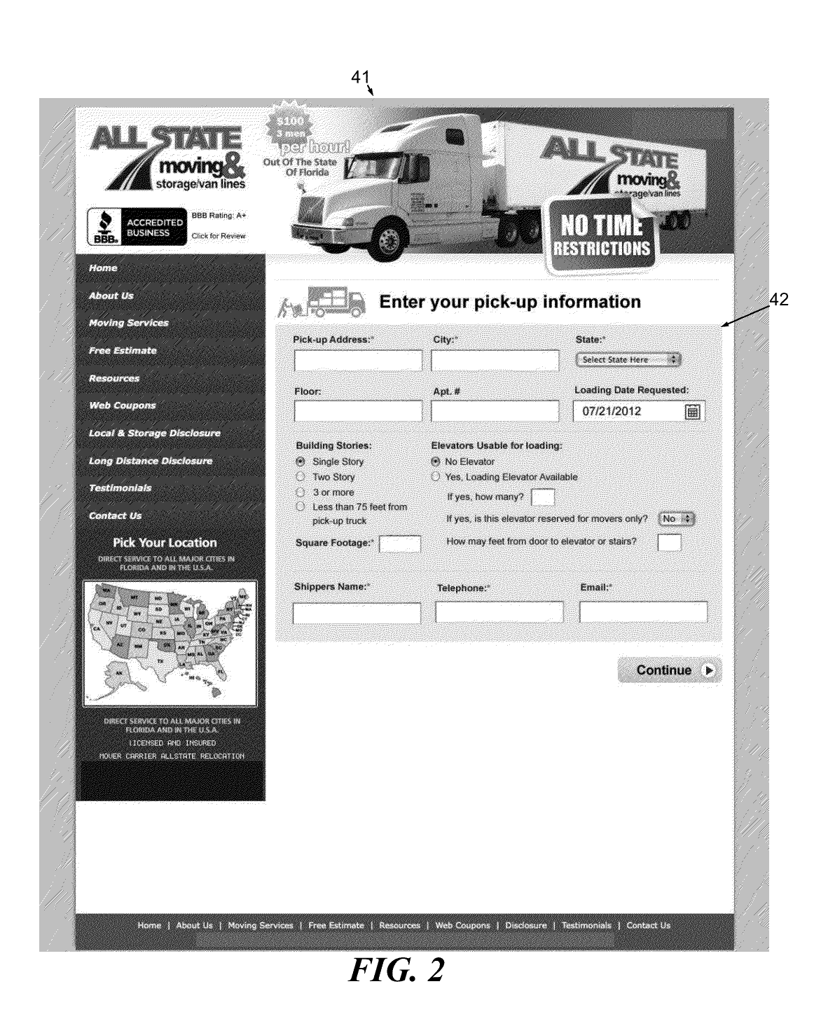

Device 12 may be a smart phone, laptop computer, tablet computer, user terminal and personal computer, among other devices capable of performing the functionality of device 12 as described herein. Device 12 may include one or more transmitters (TX(s)) 18 and one or more receivers (RX(s)) 20 for communicating with apparatus 14 and/or database 16 via network 17. Processor 22 may be one or more central processing units (CPUs) for performing device 12 functions described herein. Device 12 further includes memory 26 in communication with processor 22. Device 12 further includes display 24 that is arranged to display interface 41 (FIGS. 2-7). Display 24 may be a liquid crystal display (LCD) or light emitting diode (LED) based display or other display known in the art that is capable of displaying a website interface. Device 12 further includes input element 25 that is arranged to receive user inputs from user of device 12. Input element 25 may be a keyboard, touch screen keyboard and/or computer mouse, among other input device that allows a user to input data related to a move.

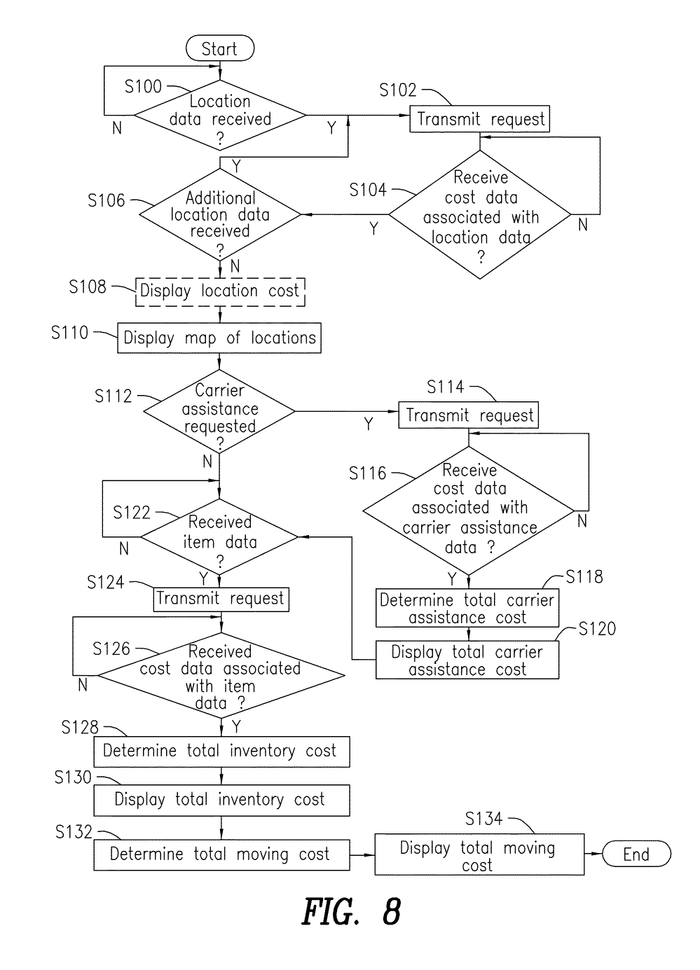

Memory 26 may include non-volatile and volatile memory. For example, non-volatile memory may include a hard drive, flash memory, memory stick and the like. Also, volatile memory may include random access memory and others known in the art. Memory 26 may store program instructions such as those for cost application 27. In particular, cost application 27 includes instructions, which when executed by processor 22, causes processor 22 to perform the cost application process, discussed in detail with respect to FIG. 8. Further, memory 26 may store user input data such that the user of device 12 may modify previously input moving information at a later time without having to re-input all the moving information, e.g., a user of device 12 may add or subtract items and/or services as needed. Alternatively, the user input data may be stored at apparatus 14 and/or database 16.

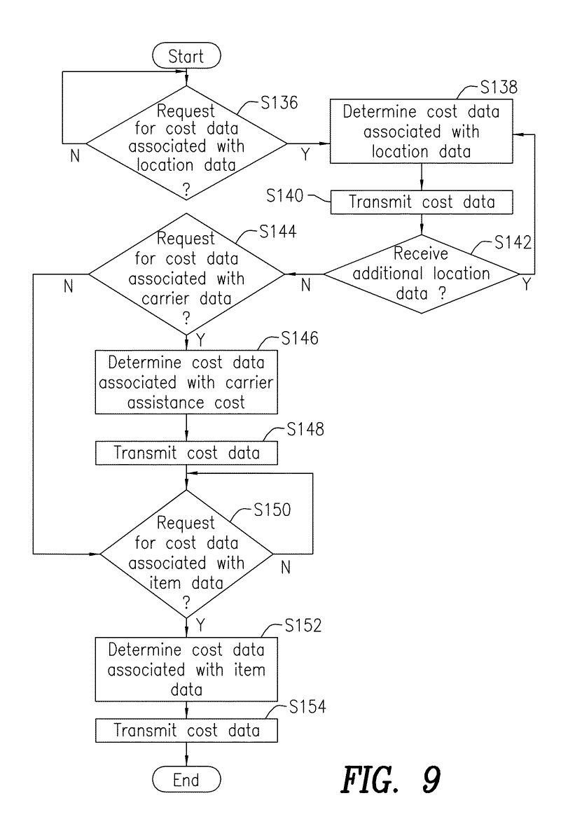

Apparatus 14 includes one or more transmitters 28 and receivers 30 arranged to communicate with device 12 and/or database 16. Apparatus 14 further includes one or more processors 32 in communication with one or more transmitters (TX(s)) 28 and one or more receivers (RX(s)) 30. Processor 32 is configured to perform apparatus 14 functions described herein. Apparatus 14 includes memory 34 in communication with processor 32 that generally corresponds to memory 26 with size and performance being adjusted based on design needs. Memory 34 may store program instructions such as those for interface module 36, among other modules. Interface module 36 includes program instructions, which when executed by processor 32, causes processor 32 to perform the interface process that supplies requested cost data, described in detail with respect to FIG. 9.

Cost data 38 includes cost values corresponding to or based on items, item weight, distance, stops, time, supplies, equipment cost and/or services associated with relocating one or more items, e.g., furniture. Cost data 38 may be predefined and dynamically updated by a moving service provider. Alternatively, cost data 38 may not be stored in memory 34 but in database 16 as discussed below. Further, memory 34 may store user input data such that the user of device 12 may modify previously input moving information at a later time without having to re-input all the moving information, e.g., a user of device 12 may add or subtract items and/or services as needed. Alternatively, the user input data may be stored at device 12 and/or database 16.

System 10 may also include one or more databases 16a to 16n (collectively referred to as “database 16”). Database 16 may be a structured query language (“SQL”) based database such as a MYSQL database or other type of database known in the art. Database 16 may store cost data 38 and user input data, among other data, as described above with respect to apparatus 14. Network 17 may include an internet protocol (“IP”) network, wireless communication network, cellular communication network and public switched telephone network (“PSTN”), among other types of networks known in the art that may be established as a wide area network (“WAN”) and/or local area network (“LAN”), such as an Ethernet LAN, among other IP-based networks.

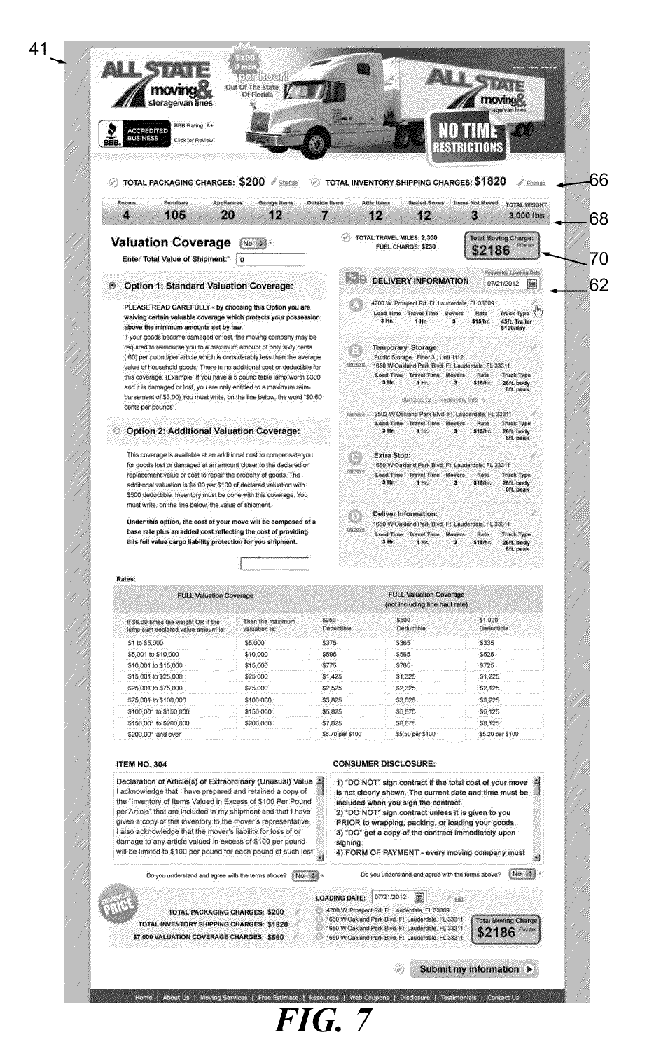

FIG. 2 is an exemplary first page of website interface 41 that is provided to device 12 by apparatus 14. Interface 41 is configured to receive user input data associated with relocating a plurality of items and display a plurality of cost estimates or quotes in which the plurality of cost estimates are based at least in part on cost data 38 and user input data. The plurality of cost estimates may be dynamically updated after at least a portion of the user data has been received, i.e., dynamically updated as the user enters or modifies user input data received at interface 41 via input element 25. For example, website interface 41 may request cost data associated with each input by the user as the user input data is received such that the estimates are dynamically calculated by processor 22. First page of website interface 41 includes pick-up information section 42 in which a user is prompted to enter information, i.e., user input data, associated with a pick-up location. For example, the pick-up information may include a pick-up location address and pick-up location characteristics, among other information related to the pick-up location. Pick-up location characteristics may include building stories, elevators usable for loading, square footage and number of feet from user's door to elevator, among other information associate with the pick-up location. The pick-up location characteristics are used to determine the number of movers or size of the moving team needed to relocate the items and an estimated time needed to relocate each item, i.e., loading/unloading time. The hourly rate of the number of movers and the estimated time are used to calculate, in part, the total moving cost (FIG. 7).

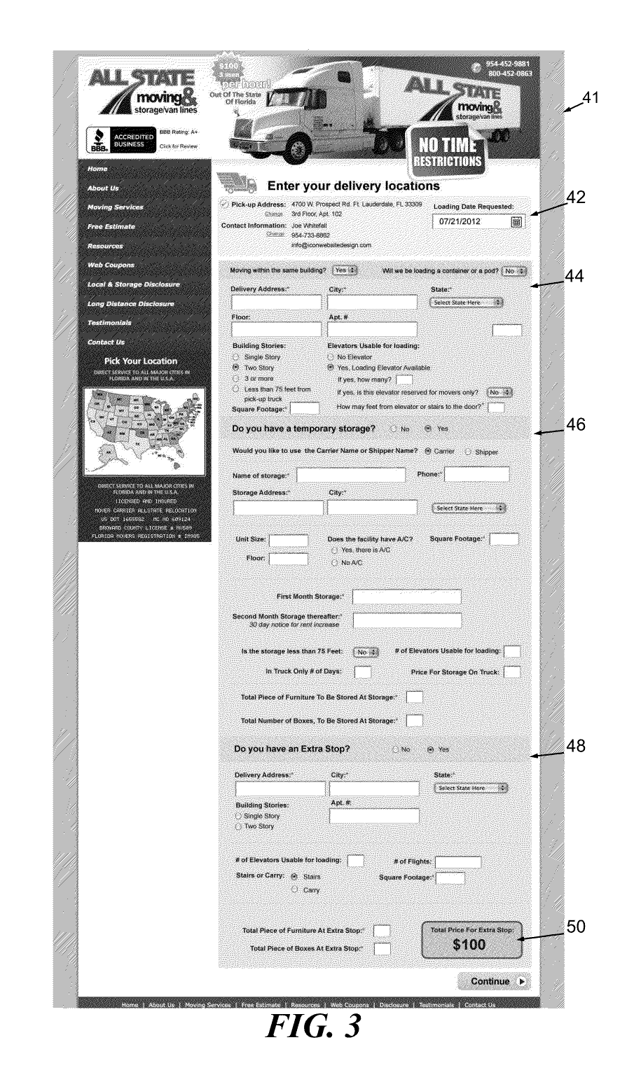

FIG. 3 is an exemplary second page of website interface 41 that is provided to device 12. Second page of website interface 41 includes a summary of pick-up information section 42, delivery section 44, temporary storage section 46, extra stop section 48 and total extra stop cost 50. The summary of pick-up information section 42 is a summary of the user input data that was entered in the first page of website interface 41 as described above with respect to FIG. 2. The summary of pick-up information section 42 allows the user to change or modify information as required without having to re-enter all the previously entered user input data, e.g., the user can change the pick-up location characteristics without having to re-enter the address information. Delivery section 44 allows user to enter delivery information, i.e., user input data, associated with a delivery location where one or more of the items are to be relocated or dropped off. For example, the delivery location may be a final destination address where any remaining relocated items on a moving vehicle are to be dropped off. The delivery information may include delivery location characteristics such as building stories, square footage, elevators usable for loading and the number of feet from elevator or stairs to the door, among other information associated with the delivery location may be used to estimate moving cost(s).

Temporary storage section 46 allows the user to enter information associated with storing at least one item to be relocated. For example, temporary storage section 46 may prompt the user for storage facility information, storage room characteristics and number of items to be stored, among other information associated with temporary storage of relocated items that may be used to estimate moving cost(s). Storage room characteristics may include unit size, floor number, whether air conditioning is provided and square footage, among other information associated with the storage room. Also, the user may indicate that no temporary storage information will be entered in which the user may later return to update temporary storage section 46.

Extra stop section 48 allows the user to enter extra stop information, i.e., extra stop data, related to one or more extra stops that are added to the travel path from the pick-up location to the delivery location. In particular, an extra stop may be an additional pick-up location or delivery location, e.g., second pick-up or delivery location. The extra stop information may include a location address, building characteristics associated with the extra stop, total pieces of furniture to be dropped off or picked up at the extra stop and total boxes to be dropped off or picked up at the extra stop, among other information associated with the one or more extra stops that may be used to calculate the extra stop cost estimate. Extra stop section 48 also displays the extra stop cost estimate that indicates the price associated the extra stop.

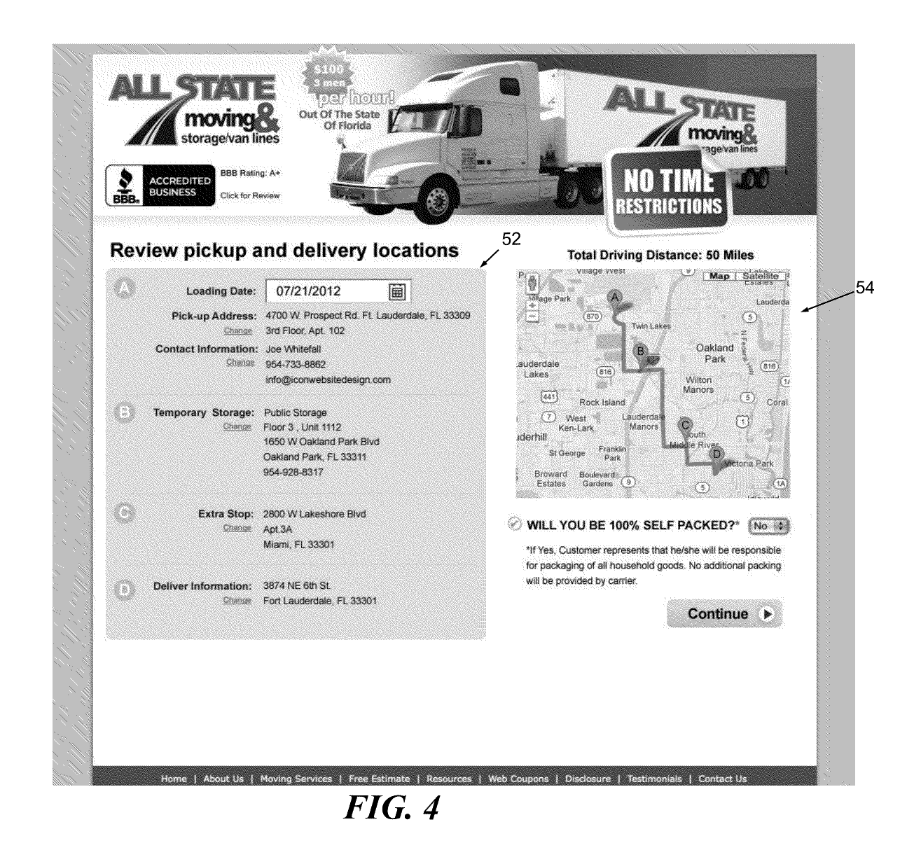

A third page of website interface 41 is illustrated with respect to FIG. 4. Third page of website interface 41 includes summary of locations 52 and mapping 54 of summary of locations 52. Summary of locations 52 includes information, i.e., user input data, corresponding to a pick-up location, delivery location, optional temporary storage location and optional extra stop(s). Summary of locations 52 allows the user to change or modify information related to one or more locations without having to resubmit all previously entered user input data, thereby facilitating user customization of the estimated cost(s), i.e., user may remove an extra stop to reduce cost or may choose an extra stop closer to the delivery location to reduce cost associated with the travel distance. Mapping 54 is a geographical map that displays the locations corresponding to the user input data and further displays the path of travel from the pick-up location to the delivery location.

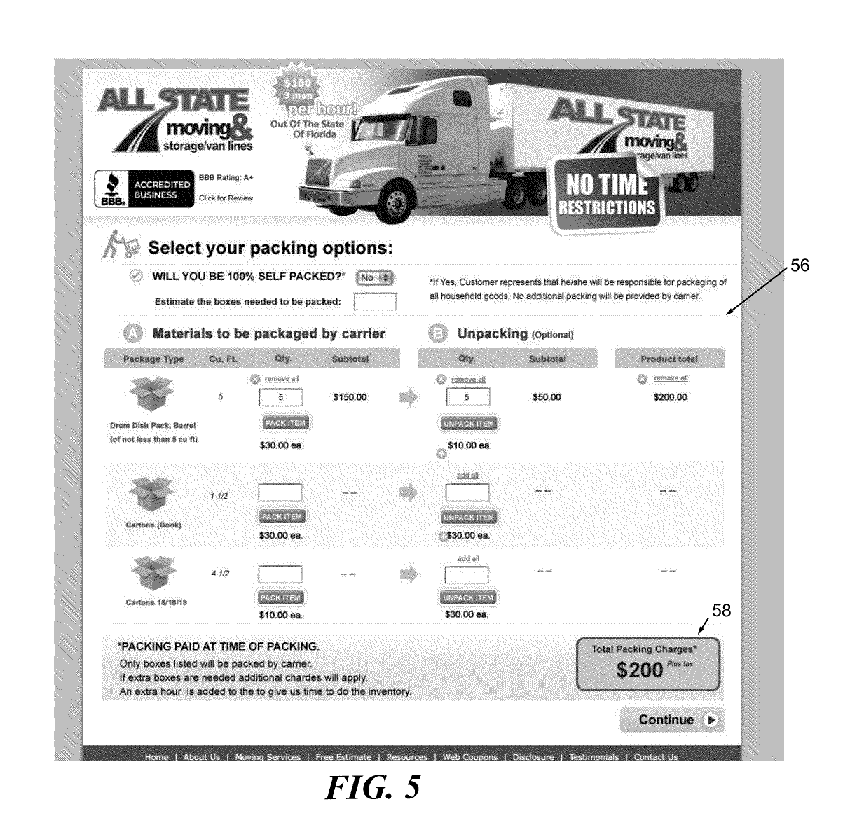

FIG. 5 illustrates a fourth page of website interface 41 that includes carrier assistance section 56. Carrier assistance section 56 allows the user to enter information related to carrier packing and/or unpacking services. For example, the user may indicate that one or more items are to be packed by the carrier in which the user indicates the amount of boxes needed to pack the item(s). The user may also indicate the amount of boxes that need to be unpacked by the carrier. An estimated cost associated with packing and/or unpacking by the carrier is displayed in total packing charges section 58, e.g., “$200”, such that the user may modify or adjust the user input data associated with carrier assisted packing to suit the user's needs and budget. Alternatively, the user may indicate no carrier assistance is needed.

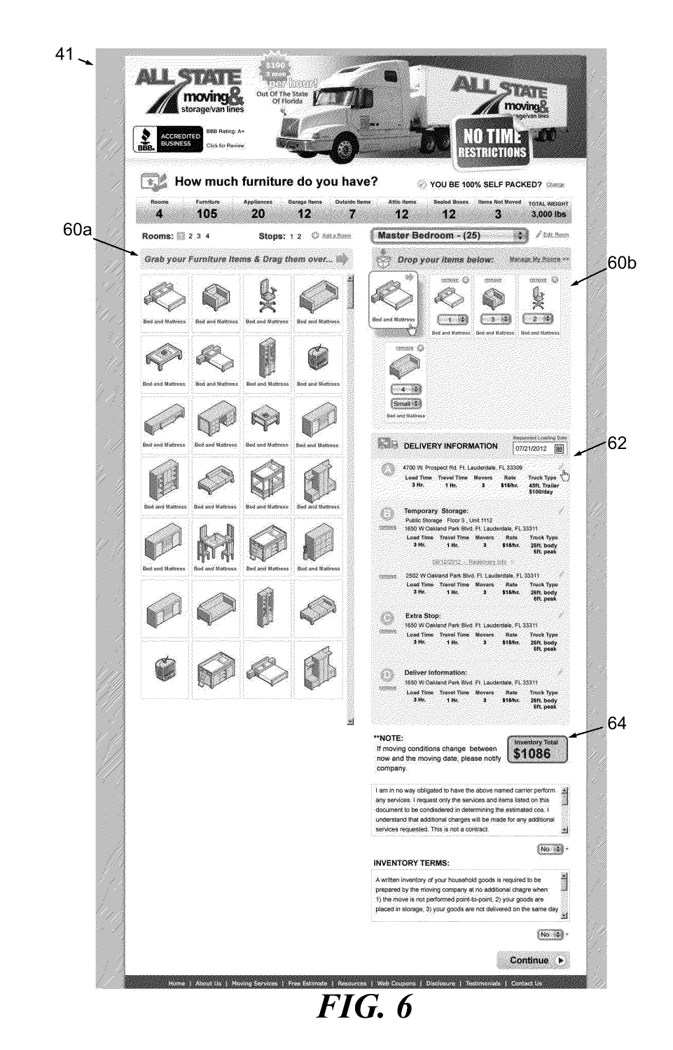

Referring to FIG. 6, there is illustrated an exemplary fifth page of website interface 41. The fifth page includes interactive furniture section 60a-60b, logistics section 62 and total inventory cost section 64. Interactive furniture section 60a allows a user to drag and drop furniture icons corresponding to items to be relocated into a predefined box section 60b such that the total number of items and item characteristics of the items to be relocated are tracked. For example, the user may customize the name(s) of box 60b to correspond to specific room, e.g., master bedroom, in which the user drags one or more furniture icons from section 60a to box section 60b such that system 10 is able to keep track of the items and items characteristics associated with items to be relocated. The user can dynamically modify the items “dropped” in box section 60b. The number of items and/or item characteristics are used in part to determine total inventory cost. For example, the item characteristics may indicate an estimated weight of an item in which the weight of the item is used in part to determine fuel cost (illustrated in FIG. 7).

Apparatus 14 and/or device 12 may printable labels and/or generate labels to be printed based at least in part on the user input data, e.g., user input data associated with section 60a and 60b. For example, the printable labels may be tracking labels for each item to be relocated in which each tracking label may include the originating and target rooms for delivery. Alternatively, the tracking label may indicate the originating room, e.g., master bedroom, and a delivery location such as temporary storage. Tracking labels help streamline the moving process by allowing the user to predetermine the exact relocation destination of the items and giving the moving service provider a “blueprint” of exactly where each item is to be relocated.

Logistics section 62 includes a summary of location logistics based on the user input data. The summary of location logistics may indicates a load time, travel time, number of required movers, hourly rate for movers (labor rate), truck type and hourly truck rate, among other information. For example, logistics section 62 may include a summary of location logistics for the pick-up location that indicates a load time of three hours, travel time of one hour, three movers are required, fifteen dollar hourly rate, a forty-five foot trailer is needed to relocate the items and the hourly rate of the truck is one hundred dollars an hour. The load time may be based at least in part on the pick-up location characteristics such as stories and elevators. The number of required movers may be based at least in part on pick-up location and/or delivery location characteristics. The truck type may be based at least in part on the item data, pick-up location characteristics and/or delivery location characteristics. The user may modify or change the location information in order to manipulate the cost of the move. For example, the user may remove extra stop “C” in order to bring the cost down. Fifth page further includes total inventory cost section 64 that displays the total cost associated with individual items to be relocated. The individual inventory cost associated with each item in section 60a is predefined or predetermined by the moving service provider in which the cost data 38 can be dynamically updated by the moving service provider.

FIG. 7 illustrated an exemplary sixth page of website interface 41 in which the sixth page includes estimated cost summary section 66, item summary section 68, logistics section 62 and total moving cost section 70. Estimated cost summary section 66 includes previously calculated cost such as total packing cost from total packing cost section 58 and total inventory cost from total inventory cost section 64, among other cost that may be dynamically calculated based at least in part on user input data, i.e., display a plurality of cost estimates. The total moving cost section 70 displays the final estimated cost or total moving cost to user in which the total moving cost includes at least the total packing cost and total inventory cost. Furthermore, device 12 and/or apparatus 14 may print and/or generate a printable estimate sheet with information for the move based at least in part on the plurality of cost estimates and user input data. For example, the estimate sheet may include items to be relocated, pick-up/delivery locations, number of movers assigned to help, number of trucks, size of trucks, payment terms, company logo(s), company contact information and notices, among other information. The printable estimate sheet provides the customer with a written version of information of the plurality of cost estimates and at least a portion of the user input data in order to help reduce ambiguity as to the terms and conditions for the move. The format of the printable estimate sheet may be dynamically reconfigured by the moving company based on design need. While the pages of website interface 41 have been described according to page number, the page numbers, page content and fields displayed in each page may be varied or modified based on design needs.

Referring to FIG. 8, there is illustrated an exemplary cost process. Processor 22 determines whether location data has been received, i.e., whether the user has input a pick-up location and destination location (Block S100). If the determination is made that location data has not been received, the determination of Block S100 may be repeated. If processor 22 determines location data has been received at interface 41, processor causes transmitter 18 to transmit a request for cost data associated with location data to apparatus 14 and/or database 16 (Block S102). In particular, the request includes location data and is requesting cost data associated with the location data such that interface 41 may calculate cost. Processor 22 determines whether cost data associated with the transmitted location data has been received (Block S104). If the determination is made that the requested cost data has not been received, the determination of Block S104 is repeated.

If the determination is made that cost data associated with location data has been received, processor 22 determines whether additional location data has been received (Block S106). For example, additional location data associated with one or more extra stops and/or temporary storage may be received. If processor 22 determines additional location data has been received, the cost application process returns to Block S102 such cost data associated with the additional location data can be requested in which the request includes the additional cost data. Additional location cost estimate may be displayed if additional location data was received (Block S108). If the determination is made that additional location data will not be received, i.e., user indicates no extra stops and/or temporary storage are needed, processor 22 causes display 24 to display a geographical map of locations corresponding the location data (Block S110). For example, interface 41 may display mapping 54.

Processor 22 determines whether carrier assistance has been requested (Block S112). For example, the user may indicate carrier assisted packing and/or unpacking are needed as illustrated in FIG. 5. If processor 22 determines carrier assistance is requested, processor 22 causes transmitter 18 to transmit a message including the carrier assisted cost data that request cost data associated with this carrier assistance data (Block S114). Processor 22 determines whether cost data associated with carrier assistance data has been received in response to message (Block S116). If processor 22 determines the cost data associated with carrier assistance data has not been received, the determination of Block S116 is repeated.

If processor 22 determines cost data associated with the carrier assistance data has been received, processor 22 determines the total carrier assistance cost based at least in part on the received cost data associated with the carrier assistance data (Block S118). Processor 22 causes display 24 to display the total carrier assistance cost (Block S120). The cost application process proceeds to Block S122 as discussed below.

Referring back to Block S112, if processor 22 determines carrier assistance is not requested, i.e., carrier assisted packing/unpacking is not requested, processor 22 determines whether item data, i.e., user input data associated with items to be relocated, has been received at interface 41 (Block S122). If processor 22 determines item data has not been received, the determination of Block S122 may be repeated. If the determination is made that item data has been received, processor 22 causes transmitter 18 to transmit a request for cost data associated with item data to apparatus 14 and/or database 16. Processor 22 determines whether the request cost data associated with the item data has been received (Block S126). If processor 22 determines the cost data associated the item data has not been received, processor 22 repeats the determination of Block S126.

If processor 22 makes the determinations that cost data associated with item data has been received, processor 22 determines a total inventory cost based at least in part on received cost data associated with the item data (Block 128). The determined total inventory cost is displayed by display 24 as illustrated FIG. 6 (Block S130). Processor 22 determines the total moving cost based at least in part on the determined additional location cost, total carrier assistance cost and total inventory cost (Block S132). Processor 22 causes display 24 to display the determined total moving cost (Block S134). Furthermore, one or more Blocks S100-S134 may be dynamically repeated based at least in part on user input data that is received from interface 41 after a respective Block has been performed, i.e., the user modifies the previously input information to customize the cost and services to the user's needs and budget.

FIG. 9 illustrates an exemplary interface process. Processor 32, at apparatus 14, determines a request for cost data associated with location data has been requested from interface 41 (Block S136). If processor 32 determines a request has not been received, processor repeats the determination of Block S136. If processor 32 determines a request for cost data associated with location data has been requested, processor 32 determines the cost data corresponding to the request (Block S138). For example, processor 32 may search memory 34 for the corresponding cost data or may alternative request the cost data from database 16. Processor causes transmitter 28 to transmit the requested cost data to interface 41 (Block S140).

Processor 22 determines whether a request for cost data associated additional location data has been requested (Block S142). If processor 32 determines a request for cost data associated with additional location data has been requested, Block S138 is repeated for the additional location data. If processor 32 determines a request for cost data associated with additional location data has not been received, processor 32 determines whether a request for cost data associated with carrier assistance data has been received (Block S144). For example, interface 41 may request cost data associated with carrier assisted packing and/or unpacking in response to receiving user input data that the user wants such assistance, as illustrated in FIG. 5.

If processor 32 determines cost data associated with carrier assistance data is requested, processor determines the requested cost data, i.e., searches memory 34 for cost data or request the corresponding cost data from database 16 (Block S146). Processor 32 causes transmitter 28 to transmit the determined cost data associated with the carrier assistance data. Processor 32 determines whether a request for cost data associated with item data has been received from interface 41 (Block S150). If processor 32 determines a request for cost data associated with item data has not been received, processor 32 repeats the determination of Block S150. If processor 22 determines the request has been received, processor 32 determines cost data associated with the item data, i.e., processor 32 search memory 34 for cost data or alternatively request cost data form database 16. Processor 32 causes transmitter 28 to transmit the cost data associated with the item data. As such, interface 41 performs the cost calculations.

Accordingly, the present invention provides a system and method that allows a user to receive an instant moving quote for one or more moving related services in which the quote is customizable, by the user, by entering modified user information to suit the user's needs and budget. It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A system for estimating costs associated with relocating a plurality of items, the system comprising:
an apparatus, the apparatus comprising:
a receiver, the receiver arranged to receive user input data associated with relocating a plurality of items; and
a processor, the processor configured to:
provide an interface to at least one device, the interface configured to:
receive the user input data associated with relocating a plurality of items;
transmit user input data to the apparatus;
calculate a plurality of cost estimates including a total moving cost, the plurality of cost estimates being based at least in part on cost data and the user input data, at least one of the plurality of cost estimates being dynamically updated after at least a portion of the user input data is transmitted; and
display the calculated plurality of cost estimates; and
determine the cost data associated with the received user input data; and
a transmitter, the transmitter arranged to transmit the cost data.

2. The system of claim 1, wherein the user input data includes at least a first pick-up location and first delivery location.

3. The system of claim 2, further comprising:
a database in communication with the apparatus, the database configured to:
store the cost data, the cost data including a plurality of individual item costs, motor vehicle cost and fuel cost, the motor vehicle cost and fuel cost being based at least in part on a distance from the first pick-up location to the first delivery location; and
provide the cost data to the apparatus, the total moving cost being based at least in part on the plurality of individual item cost, motor vehicle cost and fuel cost.

4. The system of claim 3, wherein the interface is further configured to display a geographical map, the geographical map indicating at least the first pick-up location and first delivery location.

5. The system of claim 2, wherein the plurality of cost estimates further includes at least one of an extra stop cost estimate and temporary storage cost estimate, the extra stop cost estimate corresponding to one of a second pick-up location and second delivery location situated along a path of travel between the first pick-up location and first delivery location, the temporary storage cost estimate being associated with storage of at least one of the plurality of items.

6. The system of claim 1, wherein the plurality of cost estimates further includes a packing cost estimate associated with at least one of packing and unpacking by a carrier.

7. The system of claim 6, wherein the plurality of cost estimates further includes a total inventory cost estimate based at least in part on the plurality of individual item costs associated with the plurality of items to be relocated.

8. The system of claim 1, wherein the user input data includes extra stop data associated with at least one extra stop location situated along a path of travel between the first pick-up location and first delivery location.

9. The system of claim 1, wherein the cost data includes a plurality of individual item costs corresponding to respective items to be relocated; and
the plurality of cost estimates further includes a total inventory cost based at least in part on plurality of individual item costs.

10. A method for estimating costs associated with relocating a plurality of items, the method comprising:
receiving user input data associated with relocating a plurality of items;
transmitting the user input data;
receiving cost data in response to the transmitted user input data, at least a portion of the cost data being predefined by a moving service provider;
calculating a plurality of cost estimates including a total moving cost, the plurality of cost estimates being based at least in part on cost data and the user input data, at least one of the plurality of cost estimates being dynamically updated after at least a portion of the user input data is transmitted; and
display the calculated plurality of cost estimates.

11. The method of claim 10, wherein the user input data indicates:
the plurality of items to be relocated;
a plurality of originating rooms, each originating room corresponding to a room where at least one of the plurality of items to be relocated is located;
a plurality of target rooms, the plurality of target rooms corresponding to a room where at least one of the plurality of items is to be relocated; and
the method further including generating a plurality of printable tracking labels based at least in part on the user input data, each printable tacking label arranged to:
corresponds to a respective one of the plurality of items to be relocated; and indicate the originating room and target room associated with the respective one of the plurality of items to be relocated.

12. The method of claim 10, wherein the user input data includes at least a first pick-up location and first delivery location.

13. The method of claim 10, further comprising displaying a geographical map, the geographical map indicating at least the first pick-up location and first delivery location.

14. The method of claim 10, wherein the plurality of cost estimates further includes a packing cost estimate associated with at least one of packing and unpacking by a carrier.

15. The method of claim 14, wherein the plurality of cost estimates further includes a total inventory cost estimate based at least in part on the plurality of individual item cost associated with the plurality of items to be relocated.

16. The method of claim 15, wherein the plurality of cost estimates includes at least one of an extra stop cost estimate and temporary storage cost estimate, the extra stop cost estimate corresponding to one of a second pick-up location and second delivery location situated along a path of travel between the first pick-up location and first delivery location, the temporary storage cost estimate being associated with storage of at least one of the plurality of items.

17. The method of claim 16, wherein the cost data includes a plurality of individual item costs corresponding to respective items to be relocated; and
the plurality of cost estimates further includes a total inventory cost based at least in part on plurality of individual item costs.

18. A method for estimating costs associated with relocating a plurality of items, the method comprising:
providing a website interface to at least one device;
receiving user data input from the website interface, the user input data being associated with relocating a plurality of items;
determining cost data associated with the user input data; and
transmit the determined cost data to the website interface for use in calculating a plurality of cost estimates, at least a portion of the cost data being predefined by a moving service provider.

19. The method of claim 18, further comprising:
storing the user input data;
receiving additional user input data after the plurality of cost estimates have been calculated;
updating the stored user input data based at least in part on the additional user input data; and
re-calculating the plurality of cost estimates based at least in part on the updated stored user input data.

20. The method of claim 18, further comprising:
calculating, at the website interface, the plurality of cost estimates including a total moving cost, the plurality of cost estimates being based at least in part on predefined cost data and the user input data, at least one of the plurality of cost estimates being dynamically updated after at least a portion of the user input data is transmitted; and
display the calculated plurality of cost estimates.
